(19) United States
(12) Patent Application Publication
(10) Pub. No.: US 2009/0135916 A1
(43) Pub. Date: May 28, 2009

(54) IMAGE PROCESSING APPARATUS AND METHOD

(75) Inventor: Hsin-Ming Lee, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/944,646

(22) Filed: Nov. 26, 2007

(51) Int. Cl. H04B 1/66

(52) U.S. Cl. 375/240.25; 375/E07.19

(57) ABSTRACT

An image processing apparatus for reducing memory bandwidth usage is provided. The image processing apparatus includes an informative image processing controller, a processing unit and a mixer. The informative image processing controller generates a main image and performs resolution conversion on a first designated region of the main image. The processing unit is coupled to the informative image processing controller for generating image information defining the first designated region according to a first image and outputting the image information. The mixer is coupled to the informative image processing controller for mixing the main image and the first image to generate a displayed image for displaying onto a display unit.

### BACKGROUND OF THE INVENTION

1. Field of the Invention

The invention relates to image processing, and more particularly, to an image processing apparatus and method for reducing memory bandwidth usage.

2. Description of the Related Art

Consumer electronic products have developed dramatically over the past few years. More specifically, for video systems, video system requirements have developed toward larger displays and higher display quality with increasing resolution. Meanwhile, a substantially larger amount of available memory bandwidth for video data is required to assure the quality of video image displayed in real-time.

Further, some video systems are equipped with memory-consuming functions such as on-screen displays (OSD), with controls for system configuration or showing information, interactive communications such as EPG (electronic program guide) services or e-commerce, or several programs over different channels, simultaneously being displayed on a display screen. As such, these applications generate enormous amounts of video data for a single display frame and require high data transfer rates. When the operating frequency of the memory fails to process the required memory bandwidth, the applications may be unable to properly perform their functions in a timely manner. As a result, overall performance of the video systems may be compromised.

Therefore, a need exists in the art for a method and apparatus to facilitate maximum efficiency of memory bandwidth usage required to decode video data while maintaining display quality and accommodating other memory-consuming functions.

### BRIEF SUMMARY OF THE INVENTION

It is an objective of the invention to provide an image processing apparatus and method capable of reducing memory bandwidth usage without increasing hardware requirements.

To attain the above objective, in a first aspect of the invention, an image processing apparatus is provided comprising an informative image processing controller, a processing unit and a mixer. The informative image processing controller generates a main image and performs a resolution conversion on a first designated region of the main image. The processing unit coupled to the informative image processing controller, generates image information defining the first designated region according to a first image and outputs the image information. The mixer coupled to the informative image processing controller, mixes the first image and the main image to generate a displayed image for displaying onto a display unit.

Further, the mixer performs a blending operation on the first image and the main image before mixing the first image and the main image, according to the image information. The informative image processing controller performs the resolution conversion by discarding the first designated region of the main image or adjusting the resolution of the first designated region of the main image according to the image information.

In a second aspect of the invention, an image processing method is provided comprising the step of defining a first designated region on a main image according to image information of a first image. Then, a resolution conversion is performed on the first designated region of the main image. Afterward, the first image and the main image are mixed after the resolution conversion.

In addition, a blending operation is performed on the first image and the main image according to the image information. Moreover, the resolution conversion is performed by discarding the first designated region of the main image or adjusting the resolution of the first designated region of the main image according to the image information.

In a second aspect of the invention, an image processing apparatus is provided comprising a memory unit, an informative image processing controller, a processing unit and a mixer. The memory unit is utilized to store video data. The informative image processing controller retrieves the video data from the memory unit to generate a main image according to image information. The processing unit coupled to the informative image processing controller, generates the image information defining the first designated region of a first image. The mixer coupled to the informative image processing controller, mixes the main image and the first image to generate a displayed image for video displaying.

Additionally, the image processing apparatus comprises a memory interface for providing an interface for the informative image processing controller to access the memory unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram for illustrating an image processing apparatus in accordance with one embodiment of the invention;

FIG. 2 is an image illustrating an exemplary example of the main image shown in FIG. 1;

FIG. 3 is a block diagram for illustrating an image processing apparatus in accordance with another embodiment of the invention;

FIG. 4 is an image illustrating an exemplary example of the main image shown in FIG. 3; and

FIG. 5 is a flow diagram of still another embodiment depicting an image processing method according to the invention.

### DETAILED DESCRIPTION OF THE INVENTION

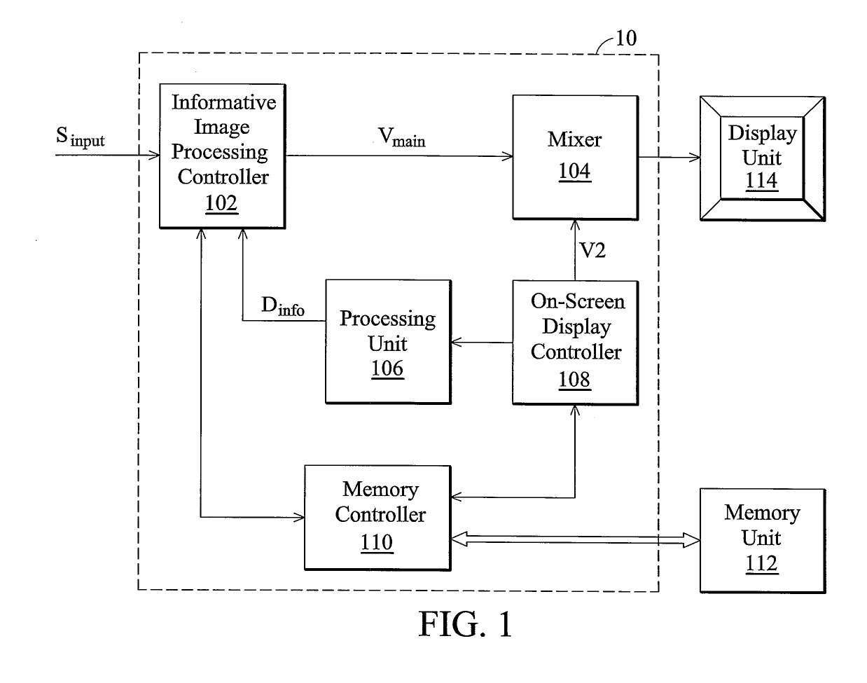

The following exemplary embodiments of the invention are described with reference to FIGS. 1 through 5, which relate to an image processing apparatus and method. It is to be understood that the following disclosure provides various different embodiments as examples for implementing different features of the invention. Specific examples of components and arrangements are described in the following to simplify the present disclosure. These are, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention relates to an image processing apparatus, which is capable of reducing memory bandwidth usage, as well as an image processing method of minimizing memory bandwidth demands for video decoding.

FIG. 1 is a block diagram for illustrating an image processing apparatus 10 in accordance with one embodiment of the invention having an informative image processing controller 102, a processing unit 106 and a mixer 104.

Referring to FIG. 1, the informative image processing controller 102 generates a main image Vₘₐᵢₙ according to video data storing in a memory unit 112. The processing unit 106, coupled to the informative image processing controller 102, generates image information D_{info} which defines a first designated region on the main image Vₘₐᵢₙ according to a first image. Generally, the image information D_{info} may include shape information (such as a circle, square or rectangle), content information (such as time, a channel number or system logo), position information (such as a start position, end position or dimensions) and blending information (such as a color depth, blending ratio or specific appearance) of the first image.

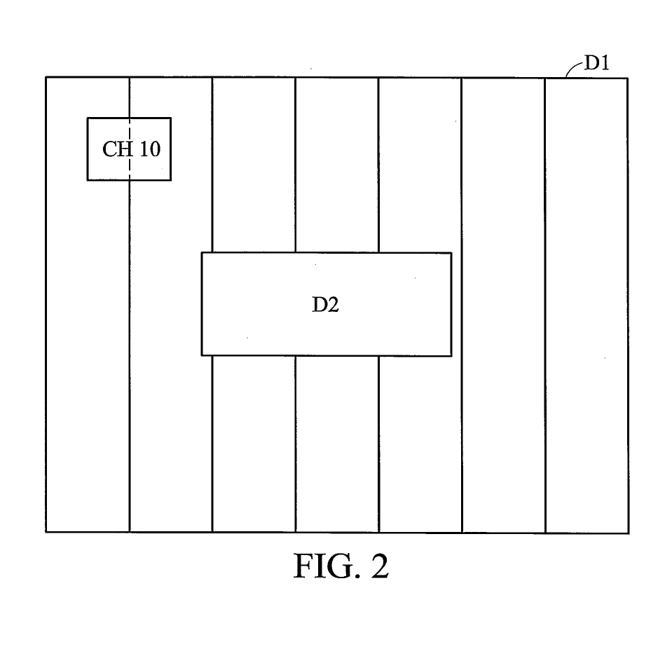

In a preferred embodiment of the invention, the first image is, but not limited to, an on-screen display (OSD) image V2 provided by an on-screen display (OSD) controller 108 according to on-screen display data from the memory unit 112. The informative image processing controller 102 performs a resolution conversion on a first designated region of the main image Vₘₐᵢₙ corresponding to the OSD image V2. For example, as shown in FIG. 2, the regions D1 and D2 represent the display regions of the main image Vₘₐᵢₙ and the first designated region of the OSD image V2 defined by the image information D_{info} respectively. The informative image processing controller 102 receives the image information D_{info} corresponding to the first designated region of the OSD image V2 and performs the resolution conversion on the first designated region D2 of the main image Vₘₐᵢₙ. The informative image processing controller 102 performs the resolution conversion by discarding the first designated region D2 of the main image Vₘₐᵢₙ or adjusting the resolution of the first designated region D2 of the main image Vₘₐᵢₙ according to the image information D_{info}. That is, after receiving the image information D_{info}, the image processing controller 102 may determine not to retrieve the video data corresponding to the first designated region D2 of the main image Vₘₐᵢₙ from the memory unit 112 or retrieve it in a lower resolution. For example, if the main image Vₘₐᵢₙ is processed in 10 bits RGB format, the image processing controller 102 can retrieve the video data corresponding to the first designated region D2 of the main image Vₘₐᵢₙ from the memory unit 112 in 9 or 8 bits format. The memory bandwidth usage of the image processing apparatus 10 is accordingly reduced.

As shown in FIG. 1, the mixer 104, coupled to the informative image processing controller 102, receives and mixes the first image and main image Vₘₐᵢₙ to generate a displayed image for displaying onto a display unit 114. In an embodiment of the invention, the mixer 104 further performs a blending operation on the first image and the main image Vₘₐᵢₙ according to blending information of the image information D_{info}. The blending information represents a blending ratio ranging from 0 to 100 percent, and indicates the transparency effect of an image, from fully transparent to solid. For example, as shown in FIG. 2, since the OSD image V2 is solid, the part of the main image Vₘₐᵢₙ within the first designated region D2 is then discarded by the informative image processing controller 102. The mixer 104 subsequently performs the blending operation on the OSD image V2 and the main image Vₘₐᵢₙ to obtain desired blending effect according to the image information D_{info}. The mixer 104 then mixes the main image Vₘₐᵢₙ and the OSD image V2 for displaying onto a display unit 114, such as a CRT or an LCD device.

Moreover, the image processing apparatus 10 further comprises a memory controller 110 coupled to the OSD controller 108 and the informative image processing controller 102 for providing an interface for the informative image processing controller 102 and OSD controller 108 to access the memory unit 112 to obtain video data corresponding to the main image Vₘₐᵢₙ and the first image therethrough. The memory unit 112 can be realized by general memory devices such as a DRAM.

As can be appreciated by those of skill in the art, the first images may comprise two or more on-screen display images. Therefore, the designated regions of the main image Vₘₐᵢₙ are respectively defined according to the two or more on-screen display images. For example, referring to FIG. 2, the designated region with transparency effect represented as “CH 10” is defined by another on-screen display image. The resolution of the designated region “CH 10” may be, for example, reduced from 24 bits of resolution (8 bits in each color dimension of red, green and blue) to 12 bits of resolution (4 bits in each color dimension).

In a preferred embodiment of the invention, the informative image processing controller 102 may generate the main image Vₘₐᵢₙ from a plurality of input video data streams Sᵢₙₚᵤₜ, such as NTSC, PAL, S-Video etc. For example, the informative image processing controller 102 may comprise a video decoder, a de-interlacer and a scalar. In the video decoder, the plurality of input video data streams Sᵢₙₚᵤₜ are demodulated and converted to the formatted signals with luminance and chroma information. The de-interlacer then converts the formatted signals to sequential frames. Further, the main image data corresponding to the sequential frames may be stored in the memory unit 112. Afterwards, according to the video data from memory unit 112, the scalar interpolates the sequential frames to generate the main image Vₘₐᵢₙ with higher resolution for display. Consequently, the efficiency of the memory bandwidth from accessing the memory unit 112 improves when access of video data corresponding to the designated regions of the main image is minimized.

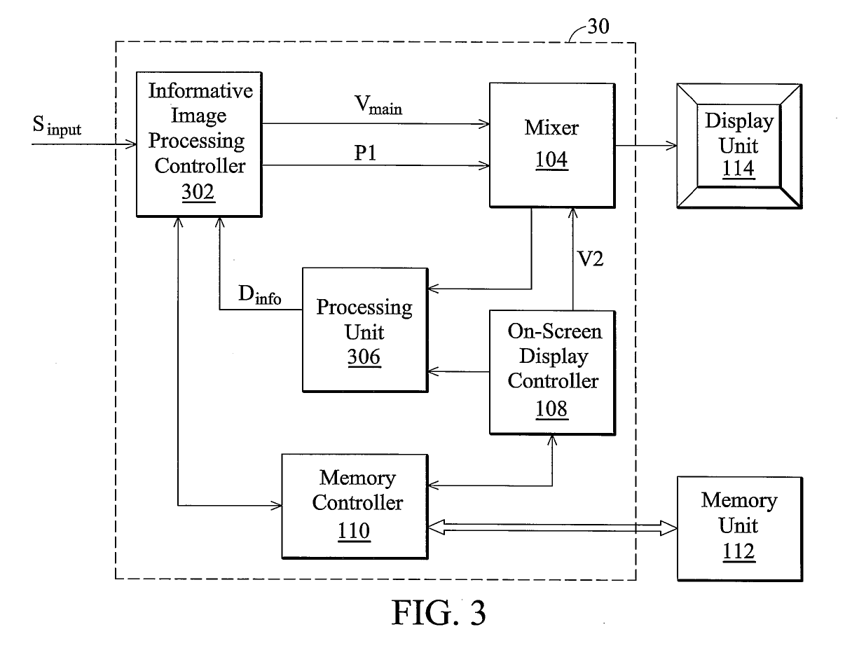

FIG. 3 is a block diagram for illustrating an image processing apparatus 30 in accordance with another embodiment of the invention. FIG. 3 uses the same reference numerals as FIG. 1 which performs the same functions, and thus are not described in further detail. In this embodiment, the first image comprises a video image P1 and an OSD image V2 generated from the informative image processing controller 302 and the OSD controller 108 respectively. Additionally, the processing unit 306 generates image information D_{info} that defines two designated regions on the main image Vₘₐᵢₙ according to the video image P1 and the OSD image V2.

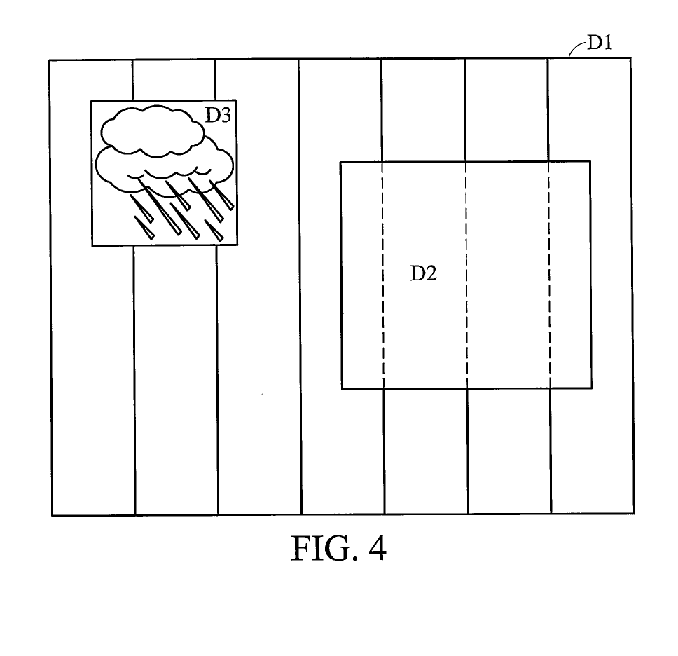

FIG. 4 shows an image example in accordance with this embodiment wherein the regions D1, D2, and D3 represent the display regions of the main image Vₘₐᵢₙ, and the first designated regions of the OSD image V2 and the video image P1, respectively. It is appreciated that the video image P1 is a Picture-in-Picture (PIP) image, displaying a channel such as a broadcast weather report, or a movie from a video cassette recorder (VCR). As shown in FIG. 4, assuming the blending ratio of the video image P1 and the OSD image V2 are 100 and 50 percent, the OSD image V2 is semi-transparent and the video image P1 is solid with no transparency effect. Accordingly, the informative image processing controller 302 discards a part of the main image Vₘₐᵢₙ within the designated regions D3 and reduces the resolution of another part of the main image Vₘₐᵢₙ within the designated region D2. The mixer 104 receives the main image Vₘₐᵢₙ with the resolution conversion performed by the informative image processing controller 302 thereon. Next, a blending operation is performed on the OSD image V2 by the mixer 104 in accordance with the blending ratio of 50 percent. The mixer 104 further mixes the main image Vₘₐᵢₙ, the video image P1 and the OSD image V2 after the blending operation for displaying onto the display unit 114.

The video image P1 may also be generated by the informative image processing controller 302 according to one of the plurality of input video data streams Sᵢₙₚᵤₜ. Further, if the video image P1 is a PIP image, the image information D_{info} defining the designated region D3 on the main image Vₘₐᵢₙ corresponding to the video image P1 is provided by the mixer 104 to the processing unit or a central processing unit (CPU). It is appreciated that in an embodiment of the invention, the processing units 106 and 306 may be a CPU of the image processing apparatuses 10 and 30 respectively and thus the image information D_{info} defining the first designated region on the main image Vₘₐᵢₙ is provided by processing units 106 and 306 directly.

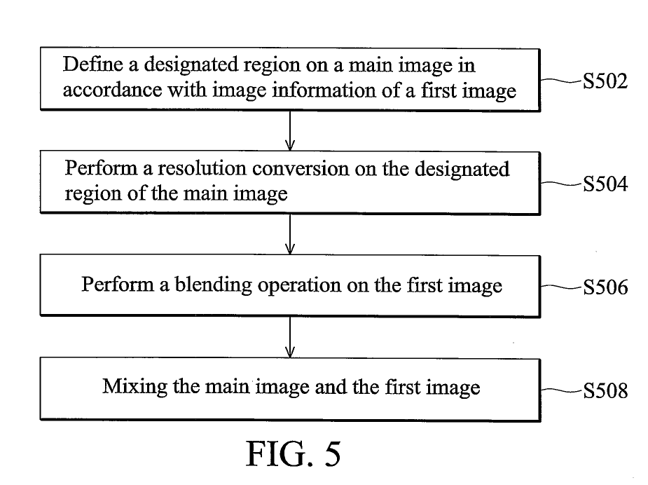

FIG. 5 is a flow diagram of still another embodiment depicting an image processing method 50 according to the invention. A first designated region is defined on a main image in accordance with image information of a first image (step S502). As mentioned above, the image information may include shape information, content information, position information for defining the first designated region, and blending information of the first image. Further, the blending information includes a blending ratio, ranging from 0 to 100 percent, indicating the transparency effect of one image, from fully transparent to solid. Moreover, the first image may be an OSD image or a PIP image. Afterwards, a resolution conversion is performed on the first designated of the main image according to the image information (step S504). In an embodiment of the invention, the resolution conversion comprises discarding the first designated region of the main image or adjusting the resolution of the first designated region of the main image according to the image information.

When the resolution conversion for the first designated region of the main image has been completed, a blending operation is preferably carried out on the first image or the main image according to the image information (step S506). It is noted that step S506 is optional.

Next, the main image and the first image are mixed after the resolution conversion (step S508).

As a result, the described embodiments of the invention preferably allow a substantial reduction in memory bandwidth demands, especially for situations not requiring blending. For a first image with no transparency effect, the designated region of the main image defined by the first image is discarded. Therefore, during the video decoding process of the main image, the data access for generating a designated region of the main image corresponding to the first image is unnecessary. Since the memory usage is reduced for video decoding, it follows that the peak memory bandwidth requirement is minimized. For a first image with transparency effect, the resolution of the designated region of the main image corresponding to the first image is reduced. As described above, data access for generating the designated region of the main image is accordingly reduced in the embodiments of the invention, reducing the memory usage.

While the invention has been described by way of example and in terms of preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing apparatus comprising:
an informative image processing controller for generating a main image and performing a resolution conversion on a first designated region of the main image;
a processing unit coupled to the informative image processing controller for generating image information defining the first designated region according to a first image and outputting the image information; and
a mixer coupled to the informative image processing controller for mixing the main image and the first image to generate a displayed image for displaying onto a display unit.

2. The image processing apparatus as claimed in claim 1, wherein the image information comprises position information for defining the first designated region of the first image.

3. The image processing apparatus as claimed in claim 1, wherein the mixer further performs a blending operation on the first image and the main image before mixing the main image and the first image, according to the image information.

4. The image processing apparatus as claimed in claim 1, wherein the informative image processing controller performs the resolution conversion by discarding the first designated region of the main image or adjusting the resolution of the first designated region of the main image according to the image information.

5. The image processing apparatus as claimed in claim 1, further comprising:
an on-screen display controller coupled to the processing unit and mixer, generating the first image.

6. The image processing apparatus as claimed in claim 1, wherein the first image is generated from the informative image processing controller.

7. The image processing apparatus as claimed in claim 6, wherein the informative image processing controller comprises a video decoder receiving a plurality of input video data streams to generate the main image and the first image.

8. The image processing apparatus as claimed in claim 1, further comprising:
a memory controller coupled to the informative image processing controller for accessing a memory unit storing the main image and the first image.

9. An image processing method comprising:
defining a first designated region on a main image according to image information of a first image;
performing a resolution conversion on the first designated region of the main image; and
mixing the main image and the first image after the resolution conversion.

10. The image processing method as claimed in claim 9, wherein the image information comprises position information for defining the first designated region of the first image.

11. The image processing method as claimed in claim 9, before the mixing, further comprising:
performing a blending operation on the first image and the main image according to the image information.

12. The image processing method as claimed in claim 9, wherein performing the resolution conversion comprises discarding the first designated region of the main image or adjusting the resolution of the first designated region of the main image according to the image information.

13. The image processing method as claimed in claim 9, wherein the first image is an on-screen display image.

14. The image processing method as claimed in claim 9, wherein the first image is a Picture-in-Picture (PIP) image.

15. An image processing apparatus comprising:
a memory unit storing video data;
an informative image processing controller for retrieving the video data from the memory unit to generate a main image according to image information;
a processing unit coupled to the informative image processing controller for generating the image information defining the first designated region of a first image; and
a mixer coupled to the informative image processing controller for mixing the main image and the first image to generate a displayed image for video displaying.

16. The image processing apparatus as claimed in claim 14, further comprising a memory interface for providing an interface for the informative image processing controller to access the memory unit.

17. The image processing apparatus as claimed in claim 14, wherein the informative image processing controller determines not to retrieve a part of the main image corresponding to the first designated region according to the image information.

18. The image processing apparatus as claimed in claim 14, wherein the informative image processing controller determines a resolution to retrieve a part of the main image corresponding to the first designated region therewith according to the image information.

19. The image processing apparatus as claimed in claim 14, wherein the first image is an on-screen display image or a Picture-in-Picture (PIP) image.

20. The image processing apparatus as claimed in claim 14, wherein the main image overlaps the first image in the first designated region.
